(19) United States
(12) Patent Application Publication
(10) Pub. No.: US 2002/0114077 A1
(43) Pub. Date: Aug. 22, 2002

(54) Integral three-dimensional imaging with digital reconstruction

(76) Inventor: Bahram Javidi, Storrs, CT (US)

Correspondence Address: CANTOR COLBURN, LLP, 55 GRIFFIN ROAD SOUTH, BLOOMFIELD, CT, 06002

(21) Appl. No.: 10/056,497

(22) Filed: Jan. 23, 2002

Related U.S. Application Data
(60) Provisional application No. 60/263,444, filed on Jan. 23, 2001.

(51) Int. Cl. G02B 27/10

(52) U.S. Cl. 359/618; 359/619; 359/626

(57) ABSTRACT

A computer-based three-dimensional image reconstruction method and system are presented. An elemental image array of a three-dimensional object is formed by a micro-lens array, and recorded by a CCD camera. Three-dimensional images are reconstructed by extracting pixels periodically from the elemental image array using a computer. Images viewed from an arbitrary angle can be retrieved by shifting which pixels are to be extracted. Image processing methods can be used to enhance the reconstructed image. Further, the digitally reconstructed images can be sent via a network. A system for imaging a three-dimensional object includes a micro-lens array that generates an elemental image array. The elemental image array is detected by a CCD camera to generate digitized image information. A computer processes the digitized image information to reconstruct an image of the three-dimensional object. A two-dimensional display device may be connected directly or indirectly to the computer to display the image of the three-dimensional object. The computer may also be used to generate virtual image information of a virtual three-dimensional object. This can then be combined with the digitized image information to provide combined image information. The two-dimensional display device may be used to display a virtual image or a combined image.

### CROSS-REFERENCE TO RELATED APPLICATION

This patent application claims priority to Provisional Application No. 60/263,444 entitled “Integral three-dimensional Imaging with Digital Reconstruction, filed on Jan. 23, 2001 by the same inventor hereof, which is incorporated herein by reference.

### TECHNICAL FIELD

This disclosure relates to integral imaging of three-dimensional objects and the digital or optical reconstruction thereof.

### BACKGROUND OF THE INVENTION

Three-dimensional image reconstruction by coherence imaging or video systems provides useful information such as the shape or distance of three-dimensional objects. Three-dimensional image reconstruction by coherence imaging is further described in J. Rosen and A. Yariv, “Three-dimensional Imaging of Random Radiation Sources,” Opt. Lett. 21, 1011-1013 (1996); H. Arimoto, K. Yoshimori, and K. Itoh, “Retrieval of the Cross-Spectral Density Propagating In Free Space,” J. Opt. Soc. Am. A 16, 2447-2452 (1999); and H. Arimoto, K. Yoshimori, and K. Itoh, “Passive Interferometric 3-D Imaging and Incoherence Gating,” Opt. Commun. 170, 319-329 (1999), all of which are incorporated herein by reference. Three-dimensional image reconstruction by video systems is further described in H. Higuchi and J. Hamasaki, “Real-time Transmission of 3-D Images Formed By Parallax Panoramagrams,” Appl. Opt. 17, 3895-3902 (1978); F. Okano, H. Hoshino, J. Arai, and I. Yuyama, “Real-time Pickup Method For A Three-dimensional Image Based On Integral Photography,” Appl. Opt. 36, 1598-1603 (1997); J. Arai, F. Okano, H. Hoshino, and I. Yuyama, “Gradient-index Lens-array Method Based On Real-time Integral Photography For Three-dimensional Images,” Appl. Opt. 37, 2034-2045 (1998); H. Hoshino, F. Okano, H. Isono, and I. Yuyama, “Analysis Of Resolution Limitation Of Integral Photography,” J. Opt. Soc. Am. A 15, 2059-2065 (1998); and F. Okano, J. Arai, H. Hoshino, and I. Yuyama, “Three-dimensional Video System Based On Integral Photography,” Opt. Eng. 38, 1072-1077 (1999), all of which are incorporated herein by reference.

Integral imaging has been used for designing three-dimensional display systems that incorporate a lens array or a diffraction grating. In existing techniques, a three-dimensional image is reconstructed optically using a transparent film or a two-dimensional ordinary display, and another lens array. For real-time three-dimensional television, it has been proposed to reconstruct three-dimensional images by displaying integral images on a liquid-crystal display. Also, it has been proposed to use gradient-index lenses (GRIN lenses) to overcome problems such as orthoscopic-pseudoscopic conversion or interference between elemental images. This optical reconstruction may introduce a resolution limitation in three-dimensional integral imaging, such is described in H. Hoshino, F. Okano, H. Isono, and I. Yuyama, “An Analysis Of Resolution Limitation Of Integral Photography,” J. Opt. Soc. Am. A 15, 2059-2065 (1998), which is incorporated herein by reference. In this way, due to the limitation of optical devices such as liquid crystal displays (LCD), the resolution, the dynamic range, and the overall quality of the reconstructed image obtained by optical integral imaging are adversely affected.

Imaging systems are further discussed in J. W. Goodman, Introduction to Fourier Optics, (McGraw-Hill, New York, 1996); B. Javidi and J. L. Homer, “Real-time Optical Information Processing, ” Academic Press 1994; S. W. Min, S. Jung, J. H. Park and B. Lee, “Computer Generated Integral Photography, ” Sixth International Workshop On three-dimensional Imaging Media Technology, Seoul Korea, pp. 21-28, July 2000 and O. Matoba and B. Javidi, “Encrypted Optical Storage With Wavelength Key and Random Codes,” Journal of Applied Optics, Vol. 38, pp. 6785-6790, Nov. 10, 1999; O. Matoba and B, Javidi, “Encrypted Optical Storage With Angular Multiplexing,” Journal of Applied Optics, Vol. 38, pp. 7288-7293, Dec. 10, 1999; and O. Matoba and B, Javidi, “Encrypted Optical Memory Using Multi-Dimensional Keys,” Journal of Applied Optics, Vol. 24, pp. 762-765, Jun. 1, 1999. B. Javidi and E. Tajahuerce, “Three-dimensional Object Recognition By Use of Digital Holography,” Opt. Lett. 25, 610-612 (2000), all of which are incorporated herein by reference.

### SUMMARY OF THE INVENTION

A computer-based three-dimensional image reconstruction method and system are presented in the present invention. The three-dimensional image reconstruction by digital methods of the present invention can remedy many of the aforementioned problems. Moreover, digital computers have been used for imaging applications and recent developments in computers allow for the application of digital methods in almost real-time. In accordance with the present invention, an elemental image array of a three-dimensional object is formed by a micro-lens array, and recorded by a CCD camera. Three-dimensional images are reconstructed by extracting pixels periodically from the elemental image array using a computer. Images viewed from an arbitrary angle can be retrieved by shifting which pixels are to be extracted. By reconstructing the three-dimensional image numerically with a computer, the quality of the image can be improved, and a wide variety of digital image processing can be applied. The present invention can be advantageously applied in applications for optical measurement and remote sensing. Image processing methods can be used to enhance the reconstructed image. Further, the digitally reconstructed images can be sent via a network, such as a local area network (LAN), a wide area network (WAN), an intranet, or the Internet (e.g., by e-mail or world wide web (www)).

A system for imaging a three-dimensional object includes a micro-lens array positioned to receive light from the three-dimensional object to generate an elemental image array of the three-dimensional object. A lens is positioned to focus the elemental image array onto a CCD camera to generate digitized image information. A computer processes the digitized image information to reconstruct an image of the three-dimensional object. A two-dimensional display device may be connected directly or indirectly to the computer to display the image of the three-dimensional object. The computer may also be used to generate virtual image information of a virtual three-dimensional object. This can then be combined with the digitized image information to provide combined image information. The two-dimensional display device may be used to display a virtual image or a combined image.

An optical three-dimensional image projector includes a first micro-lens array positioned to receive light from a three-dimensional object to generate an elemental image array of the three-dimensional object. A first lens is positioned to focus the elemental image array onto a recording device to record an image. A light source for providing a light to a beam splitter that also receives the image recorded provides a recovered image. A second lens is positioned to focus the recovered image onto a second micro-lens array to project an image of the three-dimensional object.

Another embodiment of a three-dimensional imaging system includes a first micro-lens array and a first display that generates a first image of a three-dimensional object, and a second micro-lens array and a second display that generates a second image of the three-dimensional object. These images are directed to a beam splitter to provide an integrated image of the three-dimensional object.

The above-discussed and other features and advantages of the present invention will be appreciated and understood by those skilled in the art from the following detailed description and drawings.

### DESCRIPTION OF THE DRAWINGS

FIG. 1 is a schematic representation of an optical system for obtaining image arrays in accordance with the present invention;

FIGS. 2A and B is an elemental image array from the optical system of FIG. 1, with FIG. 2B being an enlarged view of a section of the elemental image array of FIG. 2A;

FIG. 3 is a representation of an N×M elemental image array wherein each elemental image comprises J×K pixels in accordance with the present invention;

FIGS. 4A and B are schematic representations of a changing viewing angle and associated shift in accordance with the prior art;

FIGS. 5A-H are images resulting from the present invention, wherein FIG. 5A is an image of the three dimensional object, FIGS. 5B-F are reconstructed images of the three dimensional object of FIG. 5A viewed from different angles, FIG. 5G is an image of the result of contrast and brightness improvement to the image of FIG. 5A, and FIG. 5H is an image of the object of FIG. 5A with a reduction in speckle noise;

FIG. 6 is a schematic representation of a computer network connected to the optical system for conveying information to remote locations in accordance with the present invention;

FIG. 7 is a schematic representation of real time image processing of an object in accordance with the present invention;

FIG. 8 is a schematic representation of image processing of a computer synthesized virtual object in accordance with the present invention;

FIG. 9 is a schematic representation of an optical three-dimensional image projector in accordance with the present invention;

FIG. 10 is a schematic representation of a combination of a computer synthesized virtual object and a real object in accordance with the present invention;

FIG. 11 is a schematic representation of an imaging system for integrating images in accordance with the present invention; and

FIGS. 12A and B are schematic representations of display systems in accordance with an alternate embodiment of the imaging system of FIG. 11, wherein FIG. 12A is a real integral imaging system and FIG. 12B is a virtual integral imaging system.

### DETAILED DESCRIPTION OF THE INVENTION

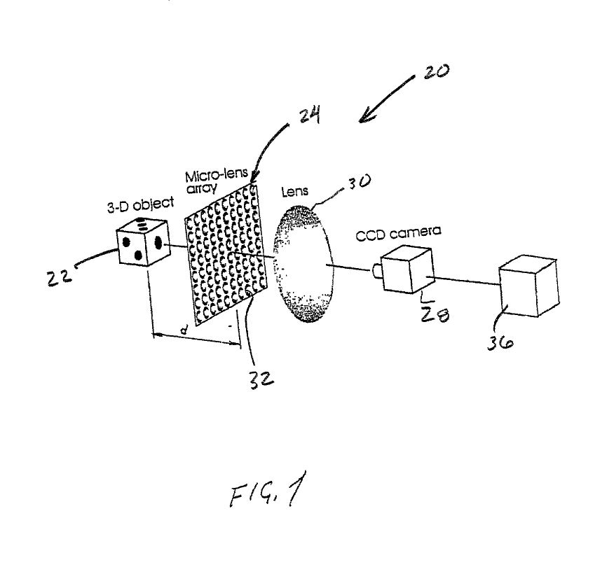

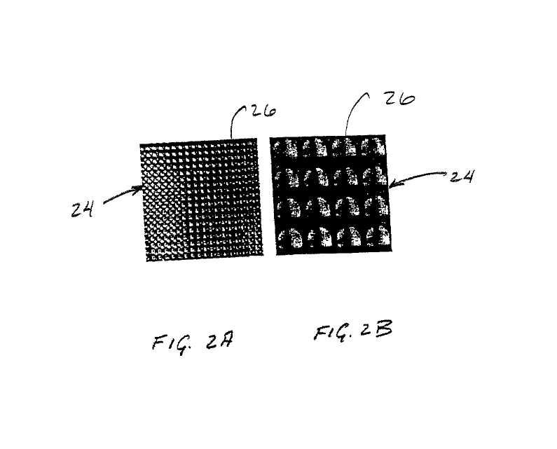

Referring to FIG. 1, a system for obtaining image arrays is generally shown at 20. A three-dimensional object (e.g., a die) 22 is illuminated by light (e.g., spatially incoherent white light). A micro-lens array 24 is placed in proximity to the object 22 to form an elemental image array 26 (FIGS. 2A and B) which is focused onto a detector 28, such as a CCD (charge coupled device) camera by a lens 30. The micro-lens array 24 comprises an N×M array of lenses 32 such as circular refractive lenses. In the present example, this N×M array comprises a 60×60 array of micro-lenses 32 in an area of 25 mm square. The magnification factor of the elemental image array formed by the camera lens 30 is adjusted such that the size of the elemental image array becomes substantially the same as the size of the imaging area of the CCD camera 28. In the present example, the distance between the object 22 and the micro-lens array 24 is 50 mm. Also, in this example, the camera lens 30 has a focal length of 50 mm. Additional lenses (not shown) may be required between the micro-lens array 24 and CCD camera 28 to accomplish sufficient magnification, such being readily apparent to one skilled in the art.

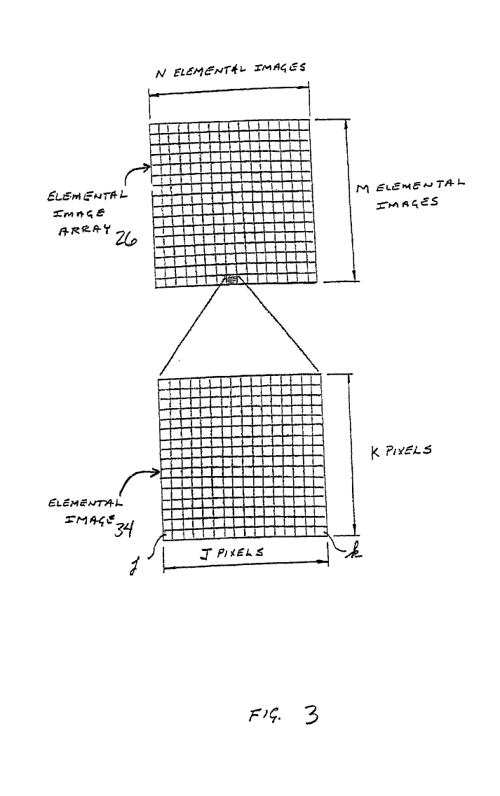

Referring to FIGS. 2A and B, elemental image array 26 of the object 200 is formed by micro-lens array 24. FIG. 2A shows a portion of the micro-lens array 24 and the elemental image array 26 formed thereby. FIG. 2B shows an enlarged section of the micro-lens array 24. Referring to FIG. 3, the CCD camera 28 comprises an H×V array of picture elements (pixels) 34. In the present example, 2029 horizontal pixels×2044 vertical pixels over an active area of about 18.5 mm square, whereby each image element is recorded over a J×K array of pixels, e.g., 34×34 pixels. Thus, H×V=N×M×J×K. Each pixel 34 of the observed elemental image array is stored in a computer (processor) 36 (FIG. 1) as, for example, 10 bits data, yielding a digitized image.

Thus, a digitized image may be reconstructed by extracting (or retrieving) information corresponding to first pixels, e.g., selected horizontal pixels, at a selected period or interval, and extracting (or retrieving) information corresponding to second pixels, e.g., selected vertical pixels, at a selected period or interval. Processing this information to in effect superposition these pixels yields a reconstructed image. Specific viewing angles of the object 22 may be reconstructed in this way. For example, in FIG. 3, to reconstruct an image at a specific viewing angle (view angle), information corresponding to the j^{th} (e.g., 34^{th}) horizontal pixel of each horizontal elemental image 26 is extracted for every J pixels or information corresponding to the k^{th}(e.g., 34^{th}) vertical pixel of each vertical elemental image 26 is extracted for every K pixels. This extracted pixel information is used to reconstruct an image viewed from a particular angle. To reconstruct images viewed from other angles, the positions of pixels (which in essence forms a grid of pixels or points) for which information is extracted is in effect shifted horizontally, vertically, or otherwise.

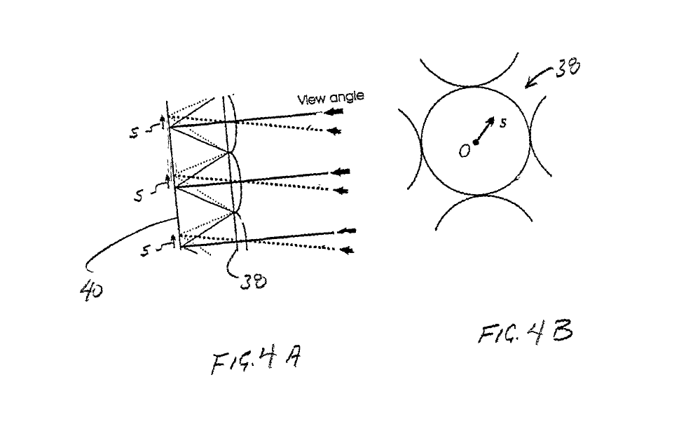

Referring to FIGS. 4A and B, in the prior art the position of points to be focused depended on view angles. In such conventional integral imaging systems, a particular point on each elemental image is enlarged by a lens array 38 placed in front of an elemental image array 40. The position of a point (O) to be enlarged is determined uniquely depending upon a viewing angle. Thusly, points (O) to be focused shift as the viewing angle changes (broken lines show shifted or changed viewing angle), such being indicated by a vector labeled (S). In contrast, the present invention is a numerical reconstruction of three-dimensional images by extracting information corresponding to periodic pixels.

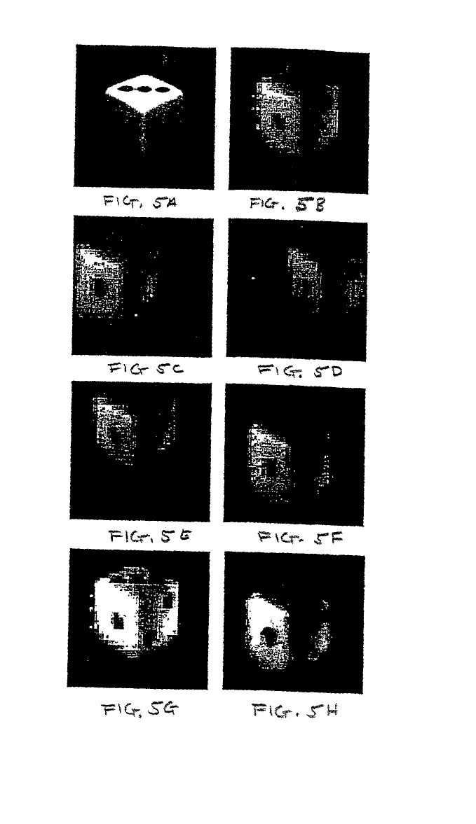

Referring to FIGS. 5A-F, examples of images reconstructed in accordance with the present invention are generally shown. While no modifications, e.g., smoothing, were made to these reconstructed images, appropriate digital image processing will improve their quality. Accordingly, it is within the scope of the present invention to further process the reconstructed images using digital image processing techniques such as contrast enhancement, filtering, image sharpening, or other techniques to improve image quality. The small dots seen in the reconstructed images of FIGS. 4B-F are the result of dead lenses in the micro-lens array 24. The resolution of the reconstructed image is, in the present example, determined by the resolution of the CCD camera 28 and the number of lenses 32 in the micro-lens array 24. The number of pixels 34 that comprise a reconstructed image is the same as the number of lenses 32 in the micro-lens array 24. Therefore, the reconstructed images shown in FIGS. 4B-4F contain 60×60 pixels. Results of simple digital image processing methods are shown in FIGS. 4G and H. The image in FIG. 4G shows the result of improving contrast and brightness of the image of FIG. 4B. The image in FIG. 4H is the result of median filtering and contrast adjustment of the image of FIG. 4F, to reduce the speckle noise.

When an object is imaged through a small aperture, details of the object can be lost. The degree of loss depends upon a number of parameters such as aperture size and the optical transfer function of a lens. By image and signal processing methods, such as the super resolution method, some of the lost details may be recovered. Also, a large number of elemental images are required to have a high quality three-dimensional image reconstruction. As a result, the detected elemental images produce a large bandwidth. A variety of image compression techniques can be employed to remedy this problem. For three-dimensional TV or video, delta modulation can be used to transmit only the changes in the scene. This is done by subtracting the successive frames of the elemental images to record the changes in the scene. Both lossless and lossy compression techniques can be used. Image quantization to reduce the bandwidth can be used as well.

A sequence of images may be reconstructed using the method of the present invention by changing the viewing angle, as discussed above, in a stepwise fashion. An animation may also be created using such a sequence. A conventional animation technique such as GIF format allows for sending the three-dimensional information using a computer network.

Referring to FIG. 6, the CCD camera 28 is connected to computer 36 as described hereinbefore. Computer 36 is connected to a network 42, such as a local area network (LAN) or a wide area network (WAN). The computer network 42 includes a plurality of client computers 44 connected to a computer server 46 from remote geographical locations by wired or wireless connections, radio based communications, telephony based communications, and other network-based communications. Computer 36 is also connected to server computer 46 by wired or wireless connections, radio based communications, telephony based communications, and other network-based communications. The computer 36 may also be connected to a display device 48, such as a liquid crystal display (LCD), liquid crystal television (LCTV) or electrically addressable spatial light modulator (SLM) for optical three-dimensional reconstruction. The computer 36 or the server computer 46 may also be connected to the Internet 50 via an ISP (Internet Service Provider), not shown, which in turn can communicate with other computers 52 through the Internet.

The computer 36 is configured to execute program software, that allows it to send, receive and process the information of the elemental image array provided by the CCD camera 28 between the computers 44, 46, 52 and display device 48. Such processing includes for example, image compression and decompression, filtering, contrast enhancement, image sharpening, noise removal and correlation for image classification.

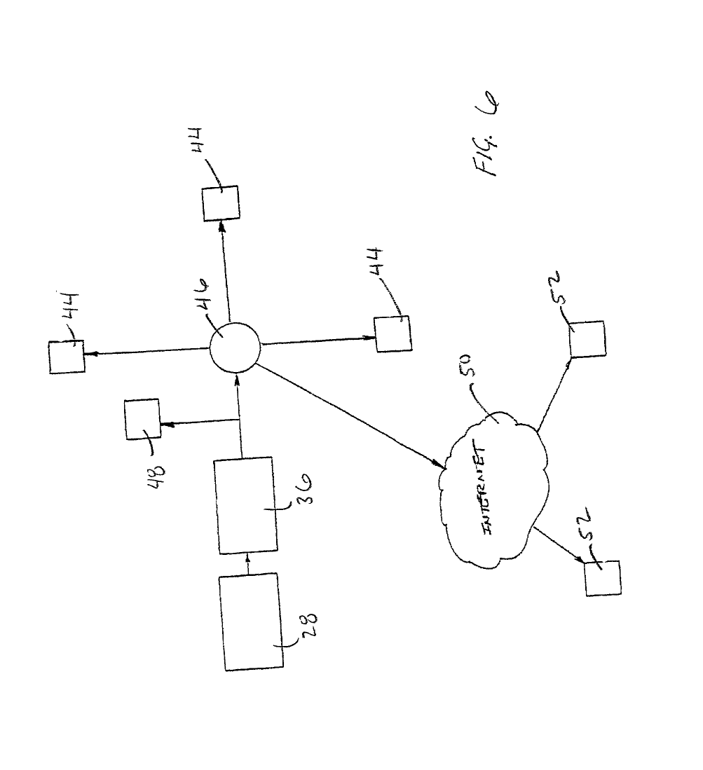

Referring to FIG. 7, a system for real time image processing is shown generally at 52. A three-dimensional object 54 is imaged by system 20 (FIG. 1) and the information is transmitted, as described hereinbefore, to remote computer 44, 52 or display device 48 (FIG. 6). Image processing such as coding, quantization, image compression, or correlation filtering is performed on the image array at computer 36 of system 20. The processed images, or simply the changes from one image to the next (e.g., sum-of-absolute-differences), are transmitted. These computers or devices include compression and decompression software/hardware for compressing and decompressing the images or data. The decompressed images are displayed on a two-dimensional display device 56, such as a liquid crystal display (LCD), LCTV or electrically addressable spatial light modulator (SLM), and an image 58 of the three-dimensional object is reconstructed utilizing a micro-lens array 60.

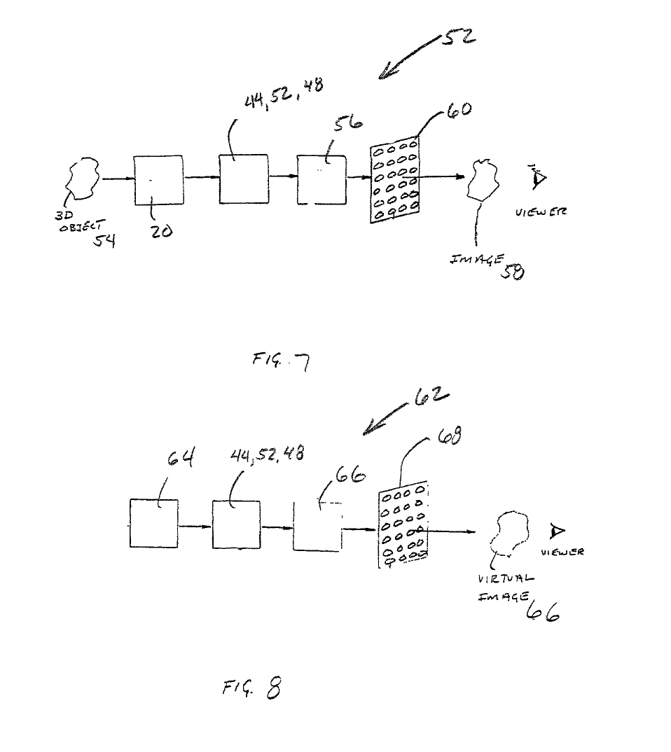

Referring to FIG. 8, an integral photography system for displaying a synthesized, or computer generated, object or movie (or moving object) is shown generally at 62. Thus, a ‘virtual’ three-dimensional object or movie is synthesized in a computer 64 by appropriate software and the information is transmitted, as described hereinbefore, to remote computer 44, 52 or display device 48 (FIG. 6). An image of the virtual object or movie is displayed on a display device 66, such as a liquid crystal display (LCD), LCTV or electrically addressable spatial light modulator (SLM), and an image 66 of the virtual object or movie is reconstructed optically utilizing a micro-lens array 68.

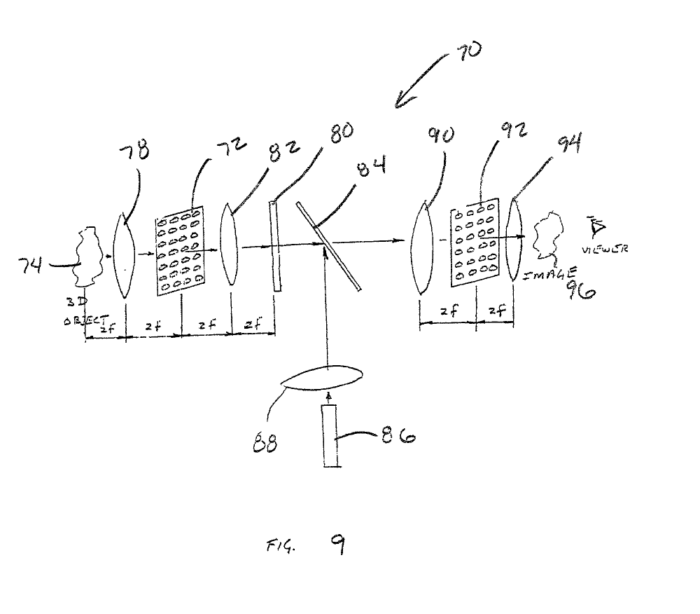

Referring to FIG. 9, an all optical three-dimensional image projector is shown generally at 70. A first micro-lens array 72 is positioned in proximity to a three-dimensional object 74 at an input plane 76 with a lens 78 disposed therebetween. An array of elemental images of the three-dimensional object is imaged onto and recorded on a recording device 80 such as an optically addressable spatial light modulator, a liquid crystal display, photopolymers, ferroelectric materials or a photorefractive material, by lens 82 operative for any necessary scaling and/or magnification. Photorefractive crystals have very large storage capacity and as a result many views of the object 74, or different objects, may be stored simultaneously by various techniques in volume holography and various multiplexing techniques such as angular multiplexing, wavelength multiplexing, spatial multiplexing or random phase code multiplexing. The images so recorded are recovered or retrieved from the recording device 80 at a beam splitter 84 by an incoherent or coherent light source 86, such as a laser beam, and a collimating lens 88. The recovered images are imaged or projected by a lens 90 to a second micro-lens array 92, which is then focused by a lens 94 to project the image 96. Thus, this technique can be used for real-time three-dimensional image projection as well as storage of elemental images of multiple three-dimensional objects.

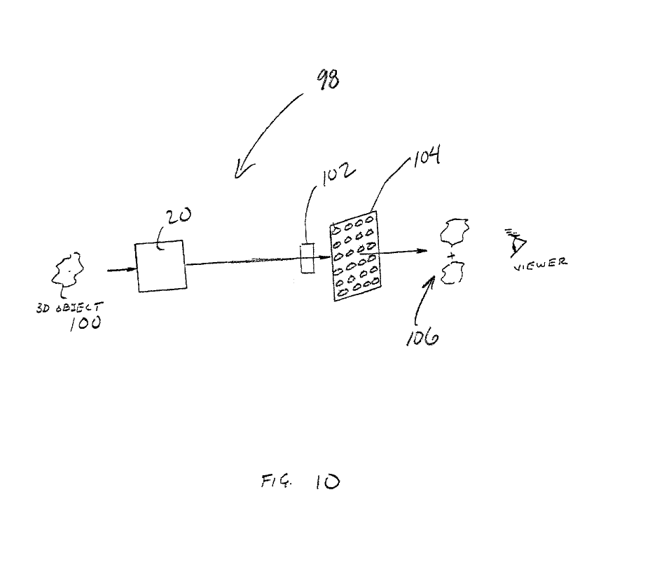

Referring to FIG. 10, a system for combining real time image processing, image reconstruction, and displaying a synthesized object is shown generally at 98. System 20 (FIG. 1) obtains a digitized image of a three-dimensional object 100 which is stored onto the computer 36 of system 20. Also, a ‘virtual’ three-dimensional object is synthesized in the computer 36 by appropriate software, as described hereinbefore. The digitized image and the synthesized image are combined (e.g., overlaid) in computer 36. The combined image 106 is reconstructed digitally in the computer 36. The combined reconstructed image can be displayed on a two-dimensional display device 102, such as a liquid crystal display (LCD), LCTV or electrically addressable spatial light modulator (SLM), and reconstructed, or projected, optically utilizing a micro-lens array 104. The combined reconstructed image may also be transmitted to computers 44, 52 or display device 48 (FIG. 6). Thus, a superposition of two or multiple three-dimensional images is reproduced optically to generate the three-dimensional images of the real-object and the computer synthesized object.

Integral photography or integral imaging (G. Lippman, “La Photographic Integrale,” Comptes-Rendus 146, 446-451, Academie des Sciences (1908); M. McCormick, “Integral 3D image for broadcast,” Proc. 2_{nd} Int. Display Workshop (ITE, Tokyo 1995), pp. 77-80; F. Okano, H. Hoshino, J. Arai, and I. Yuyama, “Real-time pickup method for a three-dimensional image based on integral photography,” Appl. Opt. 36(7), 1598-1603 (1997); B. Javidi and F. Okano, eds., “Three Dimensional Video and Display: Systems and Devices,” Information Technology 2000, Proceedings of the SPIE, Vol. CR 76, Boston, November 2000; H. Arimoto and B. Javidi, “Integral Three-dimensional Imaging with Computed Reconstruction,” Journal of Optics Letters, vol. 26, no. 3, Feb. 1, 2001; and H. Arimoto and B. Javidi, “Integral Three-dimensional Imaging with Digital Image Processing,” Critical Review of Technology of Three Dimensional Video and Display: Systems and Devices, Information Technology 2000, Proceedings of the SPIE, Vol. CR 76, Photonics East, Boston, November 2000, all of which are incorporated herein by reference) is a three-dimensional display technique that does not require any special glasses, while providing autostereoscopic images that have both horizontal and vertical parallaxes. Unlike the stereoscopic systems such as lenticular lens method, integral imaging provides continuously varying viewpoints. With integral imaging, viewing angle may be limited to small angles due to the small size of a micro-optics lens array and a finite number of display elements. (B. Javidi and F. Okano, eds., “Three Dimensional Video and Display: Systems and Devices,” Information Technology 2000, Proceedings of the SPIE, Vol. CR 76, Boston, November 2000.) Limitations in viewing angle comes from flipping of elemental images that correspond to neighboring lenses. Also, integral imaging is the limitation in depth. An integrated three-dimensional image is displayed around a central image plane. Although, pixel crosstalk increases as the image deviates from the central depth plane. (B. Javidi and F. Okano, eds., “Three Dimensional Video and Display: Systems and Devices,” Information Technology 2000, Proceedings of the SPIE, Vol. CR 76, Boston, November 2000.)

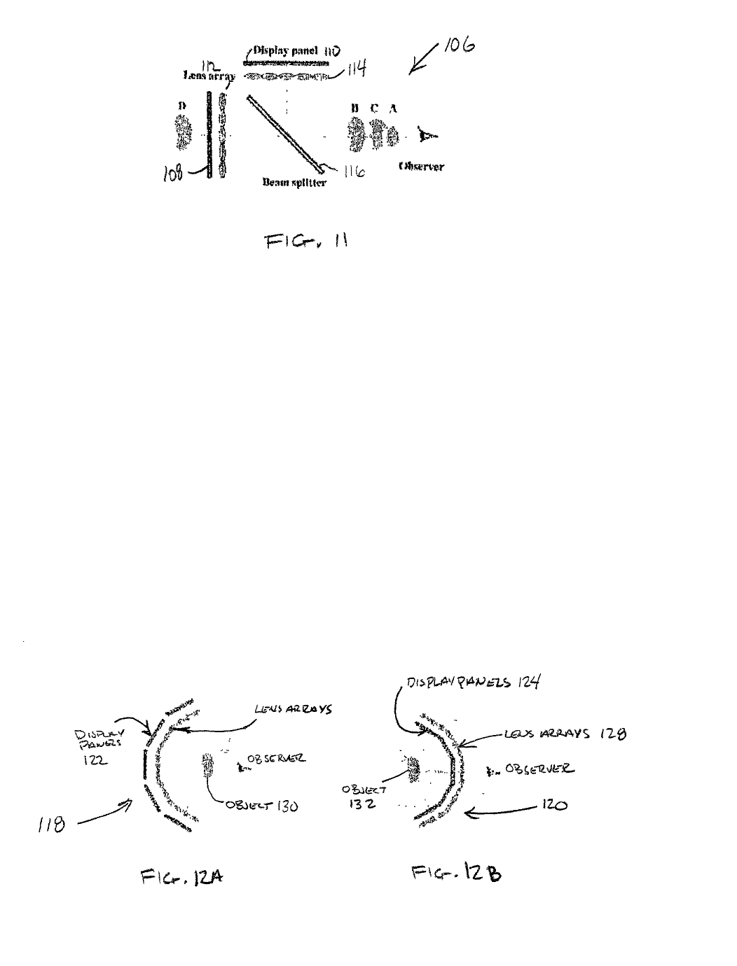

Referring to FIG. 11, a three-dimensional imaging system 106 integrates three-dimensional images of objects using two display panels 108, 110 (such as a liquid crystal display (LCD), LCTV or electrically addressable spatial light modulator (SLM)) and associated lens arrays 112, 114. The images are combined by a beam splitter 116. Real integral imaging (RII or real integral photography (RIP)) or virtual integral imaging (VII or VIP) is applicable. (B. Javidi and F. Okano, eds., “Three Dimensional Video and Display: Systems and Devices,” Information Technology 2000, Proceedings of the SPIE, Vol. CR 76, Boston, November 2000; H. Arimoto and B. Javidi, “Integral Three-dimensional Imaging with Computed Reconstruction,” Journal of Optics Letters, vol. 26, no. 3, Feb. 1, 2001 and H. Arimoto and B. Javidi, “Integral Three-dimensional Imaging with Digital Image Processing,” Critical Review of Technology of Three Dimensional Video and Display: Systems and Devices, Information Technology 2000, Proceedings of the SPIE, Vol. CR 76, Photonics East, Boston, November 2000.) RII generates an integrated image in front of the lens array and VII generates an integrated image behind the lens array. The exemplary system has a 13×13 lens array with 5 mm elemental lens diameter and 30 mm focal length. Utilizing RII in both displays 108, 110 results in two three-dimensional images A and B (FIG. 11) integrated at different longitudinal distances. Adjusting the (e.g., lenses or distance) results in cascading the two three-dimensional images as designated by A and C. In this case, the resolution can be enhanced with increased depth. If one of the two displays is in the VII mode, then three-dimensional images of A and D are simultaneously obtainable. The two display panels 108 and 110 can provide the integrated images simultaneously or they can provide them in sequence if needed. The two display 108 and 110 need not be in 90° geometry, such is merely exemplary. For example, the two display panels 108 and 110 can provide the integrated images at the same location while the overall viewing angle is increased due to the adjusted angle between the two display panels 108 and 110. Another possibility is to adjust their positions so that the two three-dimensional integrated images have the same longitudinal location but different transverse locations. This is an economic way to implement a large area three-dimensional integrated image because the display panel cost increases rapidly with size. Referring to FIGS. 12A and B, a RII system 118 and an VII system 120 system for wide viewing angle three-dimensional integral imaging using multiple display panels 122, 124 and lens arrays 126, 128 are generally shown. Due to the curved structure, the viewing angle can be substantially enhanced. With the adjustment of the distance between the display panels and lens arrays, both RII and VII structures can be implemented. By mechanically adjusting the curvature of the display panel and lens array, the three-dimensional display characteristics such as viewing angles might be integral images 130, 132 corresponding to different colors.

It will be appreciated that in all of the methods disclosed hereinabove, more than one detector can be used to record multiple views or aspects of the three-dimensional object to have a complete panaramic view e.g., a full 360° of the three-dimensional object and to display a full 360° view of the object.

The methods described herein obtain two-dimensional features or views of a three-dimensional object which can be used for reconstructing the three-dimensional object. Therefore, these two-dimensional features, views or elemental images can be used to perform classification and pattern recognition of a three-dimensional object by filtering or image processing of these elemental images.

As described above, the present invention can be embodied in the form of computer-implemented processes and apparatuses for practicing those processes. The present invention can also be embodied in the form of computer program code containing instructions embodied in tangible media, such as floppy diskettes, CD-ROM's, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium (embodied in the form of a propagated signal propagated over a propagation medium), such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A method of reconstructing an image comprising:
extracting information corresponding to periodic pixels from an array of pixels having an elemental image array of a three-dimensional object formed thereon; and
processing said information corresponding to said periodic pixels to reconstruct an image from a view angle of the three-dimensional object, said periodic pixels defining said view angle.

2. A method of claim 1 further comprising:
extracting information corresponding to other periodic pixels from said array of pixels; and
wherein said processing said information comprises processing information corresponding to said periodic pixels and said other periodic pixels to reconstruct the image from said view angle, said periodic pixels and said other periodic pixels defining said view angle.

3. The method of claim 2 wherein said periodic pixels are periodic horizontally and said other periodic pixels are periodic vertically.

4. The method of claim 1 further comprising:
extracting information corresponding to other periodic pixels from said array of pixels; and
processing said information corresponding to said other periodic pixels to reconstruct another image from another view angle of the three-dimensional object, said other periodic pixels defining said other view angle.

5. The method of claim 1 further comprising:
digital image processing the image to improve quality of the image.

6. The method of claim 5 wherein said digital image processing includes contrast enhancement or filtering.

7. The method of claim 1 further comprising recording the image that was reconstructed.

8. The method of claim 1 further comprising conveying the image that was reconstructed through a network.

9. The method of claim 8 wherein the network comprises a local area network, wide area network, intranet, or Internet.

10. The method of claim 1 further comprising displaying the image that was reconstructed.

11. The method of claim 10 wherein said displaying comprises displaying with a liquid crystal display, a liquid crystal television, or an electrically addressable special light modulator.

12. The method of claim 1 wherein said processing said information comprises combining said information of spatially related said periodic pixels.

13. The method of claim 1 further comprising:
conveying information corresponding to said array of pixels through a network to a remote location;
wherein said extracting information comprises extracting information corresponding to said periodic pixels at the remote location; and
wherein said processing said information comprises processing said information corresponding to said periodic pixels to reconstruct the image at the remote location.

14. The method of claim 13 wherein the network comprises a local area network, wide area network, intranet, or Internet.

15. The method of claim 1 wherein said array of pixels is defined by an array of lenses and a corresponding detector.

16. The method of claim 1 wherein said array of pixels further comprises a plurality of arrays of pixels each having said elemental image array of the three-dimensional object formed thereon, each of said arrays of pixels defined by a plurality of arrays of lenses and a corresponding plurality of detectors.

17. The method of claim 16 further comprising displaying the image that was reconstructed.

18. The method of claim 17 wherein said displaying comprises displaying with a plurality of displays, said displays comprising liquid crystal displays, liquid crystal televisions, or electrically addressable special light modulators.

19. The method of claim 16 wherein said processing said information comprises combining said information of spatially related said periodic pixels.

20. The method of claim 16 further comprising:
conveying information corresponding to said array of pixels through a network to a remote location;
wherein said extracting information comprises extracting information corresponding to said periodic pixels at the remote location; and
wherein said processing said information comprises processing said information corresponding to said periodic pixels to reconstruct the image at the remote location.

21. The method of claim 20 wherein the network comprises a local area network, wide area network, intranet, or Internet.

22. A system for imaging a three-dimensional object, comprising:
an array of lenses positioned to receive light from the three-dimensional object to generate an array of images of the three-dimensional object;
a lens positioned to receive said array of images generated by said array of lenses;
a detector positioned to receive said array of images from said lens to generate digitized image information; and
a processor connected to said detector to process said digitized image information to reconstruct an image of the three-dimensional object.

23. The system of claim 22 wherein:
said detector comprises an array of pixels receptive to said array of images; and
said processor process said digitized information to extract information corresponding to periodic pixels from said array of pixels to reconstruct an image from a view angle of the three-dimensional object, said periodic pixels defining said view angle.

24. The system of claim 22 wherein said array of lenses comprises a micro-lens array.

25. The system of claim 22 wherein said array of lenses comprises an array of circular refractive lenses.

26. The system of claim 22 wherein:
said detector has an imaging area receptive to said array of images from said lens; and
said lens has a magnification factor sufficient to adjust said array of images when received at said detector to a size about a size of said imaging area of said detector.

27. The system of claim 22 wherein said detector comprises a charged couple device camera.

28. The system of claim 22 further comprising;
a two-dimensional display device connected directly or indirectly to said processor to display the image of the three-dimensional object.

29. The system of claim 28 wherein said two-dimensional display device comprises a liquid crystal display, a liquid crystal television, or an electrically addressable special light modulator.

30. The system of claim 28 wherein said two-dimensional display device is connected indirectly to said processor by a network.

31. The system of claim 30 wherein said network comprises a local area network, wide area network, intranet, or Internet.

32. The system of claim 30 wherein said two-dimensional display device is connected indirectly to said processor further by a remote processor connected to said network.

33. The system of claim 28 further comprising:
another array of lenses positioned to receive light from said two-dimensional display device.

34. The system of claim 22 wherein said processor process the image using digital image processing to improve quality of the image.

35. The system of claim 22 wherein:
said array of lenses comprises a plurality of arrays of lenses each positioned to receive light from the three-dimensional object to generate arrays of images of the three-dimensional object;
said lens comprises a plurality of lenses each positioned to receive a corresponding one of said arrays of images generated by said arrays of lenses;
said detector comprise a plurality of detector each positioned to receive said corresponding one of said arrays of images from said lenses to generate a plurality of corresponding said digitized image information; and
said processor connected to said detectors to process said plurality of corresponding said digitized image information to reconstruct the image of the three-dimensional object.

36. The system of claim 22 further comprising;
a plurality of two-dimensional display devices connected directly or indirectly to said processor to display the image of the three-dimensional object.

37. The system of claim 36 wherein said two-dimensional display devices comprise liquid crystal displays, liquid crystal televisions, or electrically addressable special light modulators.

38. The system of claim 36 wherein said two-dimensional display devices are connected indirectly to said processor by a network.

39. The system of claim 38 wherein said network comprises a local area network, wide area network, intranet, or Internet.

40. The system of claim 36 wherein said two-dimensional display devices are connected indirectly to said processor further by a remote processor connected to said network.

41. The system of claim 36 further comprising:
another plurality of arrays of lenses each positioned to receive light from a corresponding one of said two-dimensional display devices.

42. The system of claim 22 wherein said processor generates virtual image information of a virtual three-dimensional object, said processor combining said digitized image information and said virtual image information of the virtual three-dimensional object to provide combined image information; and
a two-dimensional display device connected directly or indirectly to said processor to display an image, in response to said combined image information, that is a combination of the image reconstructed of the three-dimensional object and an image of the virtual three-dimensional object.

43. The system of claim 42 wherein said two-dimensional display device comprises a liquid crystal display, a liquid crystal television, or an electrically addressable special light modulator.

44. The system of claim 42 wherein said two-dimensional display device is connected indirectly to said processor by a network.

45. The system of claim 44 wherein said network comprises a local area network, wide area network, intranet, or Internet.

46. The system of claim 44 wherein said two-dimensional display device is connected indirectly to said processor further by a remote processor connected to said network.

47. The system of claim 42 further comprising:
another array of lenses positioned to receive light from said two-dimensional display device.

48. The system of claim 22 wherein said processor generates virtual image information of a virtual three-dimensional object, said processor combining said digitized image information and said virtual image information of the virtual three-dimensional object to provide combined image information; and
a plurality of two-dimensional display devices connected directly or indirectly to said processor to display an image, in response to said combined image information, that is a combination of the image reconstructed of the three-dimensional object and an image of the virtual three-dimensional object.

49. The system of claim 48 wherein said two-dimensional display devices comprise liquid crystal displays, liquid crystal televisions, or electrically addressable special light modulators.

50. The system of claim 48 wherein said two-dimensional display devices are connected indirectly to said processor by a network.

51. The system of claim 50 wherein said network comprises a local area network, wide area network, intranet, or Internet.

52. The system of claim 48 wherein said two-dimensional display devices are connected indirectly to said processor further by a remote processor connected to said network.

53. The system of claim 48 further comprising:
another plurality of arrays of lenses each positioned to receive light from a corresponding one of said two-dimensional display devices.

54. A system for generating an image, comprising:
a processor for generating information of a virtual three-dimensional object; and
a two-dimensional display device connected directly or indirectly to said processor to display an image of the virtual three-dimensional object in response to said information of the virtual three-dimensional object.

55. The system of claim 54 wherein said two-dimensional display device comprises a liquid crystal display, a liquid crystal television, or an electrically addressable special light modulator.

56. The system of claim 54 wherein said two-dimensional display device is connected indirectly to said processor by a network.

57. The system of claim 56 wherein said network comprises a local area network, wide area network, intranet, or Internet.

58. The system of claim 56 wherein said two-dimensional display device is connected indirectly to said processor further by a remote processor connected to said network.

59. The system of claim 54 further comprising:
another array of lenses positioned to receive light from said two-dimensional display device.

60. The system of claim 54 wherein said two-dimensional display device comprises a plurality of two-dimensional display devices connected directly or indirectly to said processor to display the image of the virtual three-dimensional object in response to said information of the virtual three-dimensional object.

61. The system of claim 60 wherein said two-dimensional display devices comprise liquid crystal displays, liquid crystal televisions, or electrically addressable special light modulators.

62. The system of claim 60 wherein said two-dimensional display devices are connected indirectly to said processor by a network.

63. The system of claim 62 wherein said network comprises a local area network, wide area network, intranet, or Internet.

64. The system of claim 62 wherein said two-dimensional display devices are connected indirectly to said processor further by a remote processor connected to said network.

65. The system of claim 60 further comprising:
another plurality of arrays of lenses each positioned to receive light from a corresponding one of said two-dimensional display devices.

66. An optical three-dimensional image projector, comprising:
a first array of lenses positioned to receive light from a three-dimensional object to generate an array of images of the three-dimensional object;
a first lens is positioned to receive said array of images generated by said first array of lenses;
a recording device positioned to receive said array of images from said first lens to record an image;
a light source for providing a light;
a beam splitter receptive to the image recorded and the light from said light source to provide a recovered image;
a second lens positioned to receive the recovered image; and
a second array of lenses positioned to receive the recovered image from the second lens and to project an image of the three-dimensional object.

67. The optical three-dimensional image projector of claim 66 wherein said recording device comprises an optically addressable special light modulator, a liquid crystal display, a photopolymer, a ferroelectric material, or a photorefractive material.

68. The optical three-dimensional image projector of claim 66 wherein said light source comprises an incoherent light source or a coherent light source.

69. The optical three-dimensional image projector of claim 66 wherein said light source comprises a laser.

70. The optical three-dimensional image projector of claim 66 wherein said first and second arrays of lenses each comprises a micro-lens array.

71. The optical three-dimensional image projector of claim 70 wherein said micro-lens array comprises an array of circular refractive lenses.

72. The optical three-dimensional image projector of claim 66 wherein:
said first array of lenses comprises a plurality of first arrays of lenses each positioned to receive light from the three-dimensional object to generate arrays of images of the three-dimensional object;
said first lens comprises a plurality of first lenses each positioned to receive a corresponding one of said arrays of images generated by said first arrays of lenses;
said recording device comprises a plurality of recording devices each positioned to receive said corresponding one of said arrays of images from said first lenses to record the image.

73. The optical three-dimensional image projector of claim 72 wherein said recording devices comprise optically addressable special light modulators, liquid crystal displays, photopolymers, ferroelectric materials, or photorefractive materials.

74. A three-dimensional imaging system, comprising:
a first array of lenses and a first display generates a first image of a three-dimensional object;
a second array of lenses and a second display generates a second image of the three-dimensional object; and
a beam splitter receptive to the first and second images to provide an integrated image of the three-dimensional object.

75. The system of claim 74 wherein:
said first array of lenses is positioned in front of said first display, whereby the first image is generated in front of said first array of lenses; and
said second array of lenses is positioned in front of said second display, whereby the second image is generated in front of said second array of lenses.

76. The system of claim 74 wherein:
said first array of lenses is positioned behind said first display, whereby the first image is generated behind said first array of lenses; and
said second array of lenses is positioned behind said second display, whereby the second image is generated behind said second array of lenses.

77. The system of claim 74 wherein:
said first array of lenses is positioned in front of said first display, whereby the first image is generated in front of said first array of lenses; and
said second array of lenses is positioned behind said second display, whereby the second image is generated behind said second array of lenses.

78. The system of claim 74 wherein:
said first array of lenses is positioned behind said first display, whereby the first image is generated behind said first array of lenses; and
said second array of lenses is positioned in front of said second display, whereby the second image is generated in front of said second array of lenses.

79. The system of claim 74 wherein:
said first array of lenses and said first display comprises a plurality of said first array of lenses and said first display positioned in a curved structure; and
said second array of lenses and said second display comprises a plurality of said second array of lenses and said second display positioned in a curved structure.

80. A three-dimensional imaging system, comprising:
a plurality of arrays of lenses and an associated plurality of displays generate a corresponding plurality of images of a three-dimensional object; and
means for combining said plurality of images to provide an integrated image of the three-dimensional object.

81. The system of claim 80 wherein:
at least one of said arrays of lenses is positioned in front of at least one of said associated displays, whereby at least one of said images is generated in front of said at least one of said arrays of lenses.

82. The system of claim 80 wherein:
at least one of said arrays of lenses is positioned behind at least one of said associated displays, whereby at least one of said images is generated behind said at least one of said arrays of lenses.
